(19) United States
(12) Patent Application Publication
(10) Pub. No.: US 2015/0355737 A1
(43) Pub. Date: Dec. 10, 2015

(54) Steering Wheel with Improved Interface to a Finger Navigation Module

(71) Applicant: DAIMLER AG, Stuttgart (DE)

(72) Inventors: Kwok Chiu CHEUNG, Hong Kong (HK); Volker ENTENMANN, Affalterbach (DE); Andreas KAIL, Bad Neustadt (DE); Jing MU, San Jose, CA (US); Joerg REISINGER, Loechgau (DE); Manuel STOTZEM, Wuelfershausen an der Saale (DE)

(21) Appl. No.: 14/761,905

(22) PCT Filed: Dec. 14, 2013
(86) PCT No.: PCT/EP2013/003780

§ 371 Date: Jul. 17, 2015

(30) Foreign Application Priority Data
Jan. 19, 2013 (DE) 10 2013 000 944.8

(51) Int. Cl. G06F 3/0354; G06F 3/038; B62D 1/04

(52) U.S. Cl. CPC G06F 3/03547; B62D 1/046; G06F 3/038; G06F 2203/0383

(57) ABSTRACT

A steering wheel for a motor vehicle is disclosed. The steering wheel includes an optical finger navigation module, a steering wheel electronics unit, and a communication device for data transmission between the optical finger navigation module and the steering wheel electronics unit. The communication device is a data bus with two lines for data transmission and one line for clock pulse transmission.

### BACKGROUND AND SUMMARY OF THE INVENTION

The present invention relates to a steering wheel for a motor vehicle with an optical finger navigation module, a steering wheel electronics unit and a communication device for data transmission between the optical finger navigation module and the steering wheel electronics unit.

An optical finger navigation module (OFN) can be integrated into the switch block of a motor vehicle steering wheel as a sensor for the detection of finger movements. The sensor data have to be transmitted via a data bus connection from the OFN to the steering wheel electronics unit (LRE); cf. FIG. 1). In the process, the available construction space in the steering wheel for the plug and cable connections is severely limited. In addition, the communication between the OFN and the steering wheel electronics unit should be resistant to external interference and synchronized with the data transmission from the steering wheel electronics unit to a column tube switch module in the steering column.

In the so-called “consumer electronics”, an OFN 1 is also frequently used (cf. FIG. 2). There, the OFN 1 is directly connected to a printed circuit board 2, which also has a microcontroller 3 that evaluates the OFN data.

In the consumer electronics, the OFN 1 and microcontroller 3 communicate with one another as a rule via an I2C-interface (Inter-Integrated-Circuit). This serial interface is designed for communication between controllers on a circuit board and requires only two signal lines 4 and 5 (Serial Clock SCLK and Signal Data SDA). If the OFN detects a finger movement on its surface, it initiates communication with the microcontroller 3 by sending an interrupt to the microcontroller 3. To this end an interrupt line 7 (MOTION_N) between the OFN 1 and the microcontroller 3 is necessary. Thus a total of three lines are necessary for operation. However, the interference immunity of the I2C-interface for motor vehicle applications is not sufficient for the necessary data transmission in the steering wheel between the OFN 1 and the LRE via long signal lines,

A known “SPI” interface (Serial peripheral interface) would be sufficiently robust for application in a motor vehicle steering wheel. FIG. 3 shows a schematic representation of a connection of an OFN via an SPI interface to a microcontroller 3. As in the example from FIG. 2, the printed circuit hoard 2 of the steering wheel electronics unit LRE is equipped with the microcontroller 3. The electronics unit 6 of the OFN 1 is arranged on a printed circuit board 8 of a multifunction switch (MFS). The microcontroller 3 and the electronics unit 6 of the OFN 1 each have an SPI interface 9, 10. By default, this SRI interface requires four data lines. Three data lines 11, 12 and 13 are required for the actual data transmission, namely SCLK (Serial Clock), MOSI (Master Out Slave In), MISO (Master In Slave Out). The master (here the microcontroller 3) uses the fourth line 14 (SS; Slave Select) to select the slave (here OFN 1) with which it wants to communicate. Hence, in principle, several slaves can communicate with a master, wherein the slaves can share the three data lines, but each requires a separate Slave-Select-line. However, an increased construction space requirement in the steering wheel results from the four signal lines of the SPI interface 9, 10 for plugs 15, 16 to the two printed circuit boards 2, 8 as well as the corresponding cable set. In addition, there is the construction space requirement for a fifth line 17, which is necessary for the interrupt procedure, similar to the example from FIG. 2.

In the consumer electronics, the data transmission between the microcontroller 3 as master and the OFN 1 as slave is initiated by the OFN 1. For this purpose, the separate signal line 17 is used for the so-called Motion_Interrupt. If the OFN 1 detects a change in the touch or motion state of the finger on its surface, it sends a motion interrupt to the master 3. The master then starts the query of the OFN data via the serial interface 9, 10.

This communications concept has the advantage for consumer electronics that, event-dependently, there is only communication between master and slave when a finger movement takes place. This leads to a minimal energy requirement, which is an important aspect for mobile devices. However, this aspect is of secondary importance for application in the steering wheel. What is disadvantageous for application in the steering wheel is the fact that an additional signal line is required for the Motion-Interrupt, which further exacerbates the construction space problem. For another thing, this event-based communication can only be synchronized with the further cyclical data transmission between the steering wheel electronics unit and the column tube switch module with great difficulty.

Hence, the object addressed by the invention is that of providing a steering wheel that makes possible an interference-tree operation of an OFN with low construction space requirements.

An inventive steering wheel for a motor vehicle is thus equipped with an optical finger navigation module, a steering wheel electronics unit and a communication device for data transmission between the optical finger navigation module and the steering wheel electronics unit. In the process, the communication device comprises a serial data bus with only three lines, wherein two of the three lines are designed for data transmission and one is designed for clock pulse transmission.

Thus, in an advantageous manner, a data bus with only three lines is provided between the optical finger navigation module and the steering wheel electronics unit. Hence, compared to four or five lines, there is a significant construction space saving to be registered. As a result of the fact that two lines are provided for the data transmission, in a development of the inventive steering wheel, a line for communication from the steering wheel electronics unit to the OFN and the other data line can additionally be used for the communication in the reverse direction, resulting in further freedom from interference.

The steering wheel electronics unit is preferably designed to poll the OFN module via the communication device. This polling makes it possible to dispense with a separate interrupt line.

The data bus can in particular be an SPI data bus. The SPI data bus is characterized by sufficient interference immunity.

The OFN module can furthermore be designed to detect a finger movement on the surface of the OFN module as at least a differential value that describes a distance travelled by a finger in a communications cycle. Through the differential value, it is possible to securely detect whether a finger has moved on the surface of the OFN module.

In particular, the OFN module can be designed to calculate a sum value from several differential values and transmit the sum value via the communication device to the steering wheel electronics unit. In addition, the steering wheel electronics unit can be designed to calculate a differential value from a transmitted sum value and a stored additional sum value as an indicator for a finger movement. Thus, if sum values are transmitted from the OFN module, on the receiving side it is possible by processing, in particular forming differential values of the sum values, to also extrapolate a movement when a data value is not transmitted due to an error.

In a further embodiment, the steering wheel electronics unit is designed to control a temperature compensation of the OFN module with the help of data stored internally or provided in the steering wheel electronics unit. Compared to the conventional temperature compensation, in which only internal data of the OFN module are used, this has the advantage that data obtained outside of the steering wheel electronics unit or outside of the OFN module, such as ambient temperature, interior temperature, etc. can be used for temperature compensation.

In addition, the steering wheel electronics unit can be equipped with a microprocessor which has at least two SPI interfaces, wherein the OFN is connected via one of the SPI interfaces and, via another one of the SPI interfaces, an additional OFN module is connected. This makes it possible to connect the OFN modules of two switch blocks of a steering wheel in inventively advantageous manner to a central steering wheel electronics unit.

The steering wheel can also be in a communications connection with a column tube switch module of a steering column, wherein communication between the GEN module and the steering wheel electronics unit is synchronized with communication between the steering wheel electronics unit and the column tube switch module. This synchronization has the advantage of a time optimized transmission.

In particular, it is of advantage when a motor vehicle is equipped with the inventive steering wheel.

The present invention will be described in greater detail with the assistance of the attached drawings.

### BRIEF DESCRIPTION OF THE DRAWINGS

FIG. 1 shows a schematic sketch of a steering wheel with optical finger navigation modules;

FIG. 2 shows an OFN module, which in accordance with the prior art is connected via a I2C-interface;

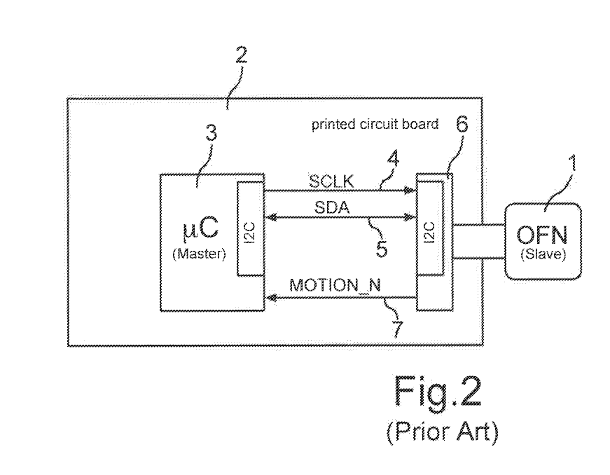

FIG. 3 shows an OFN module, which in accordance with the prior art is connected via a 4-wire SPI interface; and

FIG. 4 shows an OFN module, which in accordance with the invention is connected to a 3-wire SPI interface.

### DETAILED DESCRIPTION OF THE DRAWINGS

The exemplary embodiments described in greater detail below illustrate preferred embodiments of the present invention.

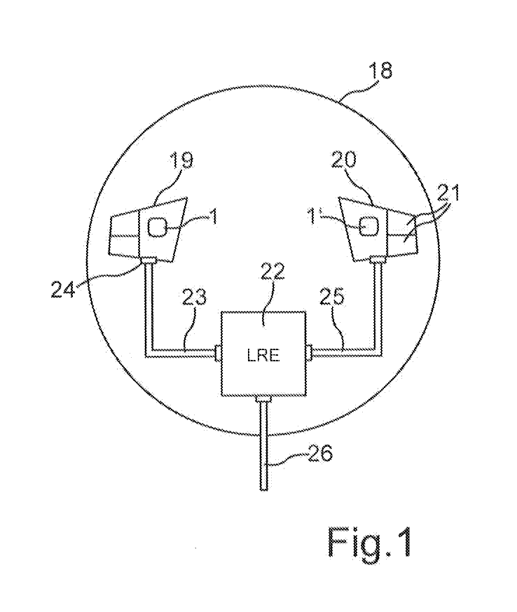

FIG. 1 shows a schematic representation of a steering wheel 18. On the steering wheel there are two switch blocks 19 and 20 in ergonomically appropriate positions, the switch blocks also being able to be referred to as multifunction switches (MFS). In other exemplary embodiments, only one such switch block is provided or more than two switch blocks or multifunction switches are provided.

In the example from FIG. 1, each switch block 19, 20 has an optical finger navigation module (OFN). In addition, the switch blocks 19 and 20 each have additional mechanical control elements 21. A cable 23 is used to transmit the data from the left switch block 19 to a steering wheel electronics unit 22 (LRE), the cable being equipped with plugs 24 on its ends. Similarly to this, the communication from the right switch block. 20 to the steering wheel electronics unit 22 takes place via a cable 25. The signal output from the steering wheel electronics unit 22 to, for example, a column tube switch module (not shown in FIG. 1) takes place via a further cable 26.

As initially mentioned, each OFN 1 serves as a sensor for the detection of finger movements. The cables 23 and 25 are used for the implementation of a data bus connection or communication device between the OFN modules 1 and the steering wheel electronics unit 22.

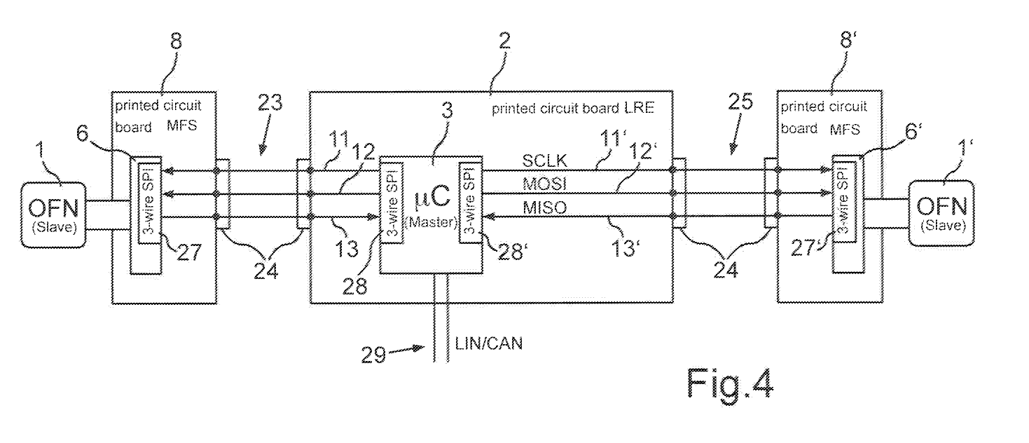

The communications connection between the OFN modules (short: OFN) and the steering wheel electronics unit 22 is schematically illustrated in FIG. 4. in this example the steering wheel is also designed with two OFNs 1 and 1′. However, the number can vary depending on the embodiment, as mentioned earlier.

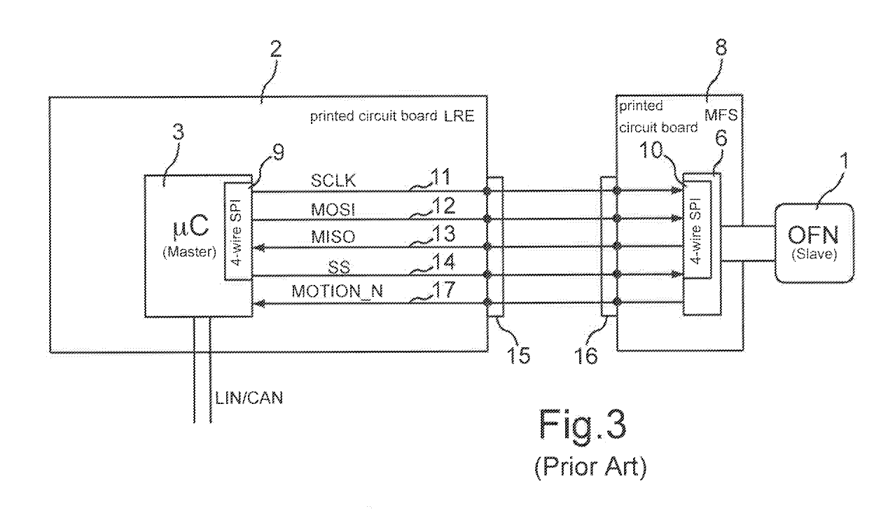

As in the example from FIG. 3, a plug 6 is arranged on the printed circuit board 8 of the multifunction switch. The OFN 1 is connected to the printed circuit board 8 via the plug 6. The OFN 1 has a 3-wire SPI interface 27, which connects it to the microcontroller 3, which is located on the printed circuit board 2 of the steering wheel electronics unit. The first cable 23 with the plugs 24 is triple core and connects the printed circuit board 8 to the printed circuit board 2.

The microcontroller 3 on the printed circuit board 2 of the steering wheel electronics unit has a first 3-wire SPI interface 28. The three signal lines 11 through 13 correspond to the first three signal lines of the 4-wire SPI interface from the example in 1 3. Thus the signal line 11 is allocated to the “Serial Clock” SCLK, the data line 12 is allocated to the “Master Out Slave in” MOSI and the data line 13 is allocated to the “Master In Slave Out” MISO. The microcontroller 3 thus switches the OFN 1.

Similarly to this, the right OFN 1′, whose plug 6′ is arranged on the printed circuit board 8′ of the right multifunction switch, is connected for the purpose of data exchange to the microcontroller 3 of the steering wheel electronics unit on the printed circuit board 2. To this end, the OFN 1′ likewise has a 3-wire SPI interface 27′, which is connected to a corresponding 3-wire SPI interface 28′ of the microcontroller 3 via the cable 25 with the plugs 24. The three signal lines 11′ through 13′ (for simplicity's sake also called data lines) similarly conduct the signals or SCLK, MOST and MISO data.

The microcontroller 3 is connected via a data bus 29 to additional electronic units, in particular a column tube switch module. The data bus 29 can be a LIN bus or CAN bus.

Thus, in the case of the inventive communications connection or device, a 3-wire SPI interface is selected for the OFN wherein the Slave-Select and the Motion-interrupt lines are dispensed with. Hence, a corresponding construction space advantage results in comparison with the implementation from FIG. 3 while maintaining the interference immunity.

By virtue of the topology, in the steering wheel, the left and the right OFN 1, 1′ have to be connected via separate cables 23, 25 to the steering wheel electronics unit. That means that each OFN, as described above, has separate SPI data lines 11 through 13 or 11′ through 13′. If the microcontroller 3 with the two SPI interfaces is now used in the steering wheel electronics unit, to which the respective OFN is connected, the Slave-Select lines can be dispensed with. Per SPI interface 28, 28′ there is namely only one slave (OFN), which is always active and communicates with the master (LRE or Microcontroller 3).

Moreover, the communication between the steering wheel electronics unit LRE and OFN is controlled exclusively by the LRE as the master. The LRE polls every OFN continuously in brief intervals, that is, cyclically, so that changes of the finger state can be rapidly detected. The energy requirement resulting from this polling strategy, slightly increased in comparison to an event-controlled communication, is acceptable for application in the steering wheel. The advantages are that the Motion-Interrupt line is no longer required and the SPI communication with the further data transmission by LIN bus or CAN bus to the column tube switch module can be synchronized.

Along with the hardware adjustment of the SPI interface, optimizations in protocol can also be performed. This will be explained in greater detail in the following.

The OFN 1 or 1′ typically records a finger movement in the form of differential values Δx and Δy, which describe the movement of the finger in the respective coordinate direction (x- and y-axis) since the last data query via the serial interface. In consumer electronics, these differential values are directly transmitted. In the process, if a message is lost due to outside interference, there is no possibility of reconstructing their content from the preceding and following messages.

For this reason, the OFN 1 or 1′ in the steering wheel here does not transmit the differential values Δx and Δy, but rather the sum values x and y that are continuously calculated from them. Thus the sum value x is calculated as the sum of all preceding differential values Δx and the sum value y is calculated as the sum of all preceding differential values Δy. Then, in the LRE the differential values are again formed by subtraction of the last of the current sum values. If a message gets lost, the difference can also be formed from the values of the following and preceding messages. In this way the loss of the message can be compensated for.

In order to be able to correctly record the finger movement under all temperature conditions, the OFN 1 or 1′ must carry out a temperature compensation of its sensors from time to time. In the consumer electronics the OFN itself determines the time for this. Typically the temperature compensation takes place automatically at set intervals. In the case of application in the steering wheel, on the other hand the LRE controls the temperature compensation in the OFN via the SPI interface. By means of the data connection to the motor vehicle (data bus 29) there is a great deal of context information in the LRE, with the assistance of which decisions can be made as to whether and at which intervals temperature compensation is necessary. Examples of relevant information are the ambient temperature, the interior temperature and the operating state of the steering wheel heater.

The advantages of the 3-wire SPI interface between OFN and LRE lie in a minimal construction space requirement for the plug and the cable set as well as in data transmission that is resistant to external interference. With a total of three signal lines, more lines are no longer necessary as in consumer electronics. At the same time, the OFN and the LRE can be spatially separate.

1.-10. (canceled)

11. A steering wheel for a motor vehicle, comprising:
an optical finger navigation module;
a steering wheel electronics unit; and
a communication device for data transmission between the optical finger navigation module and the steering wheel electronics unit;
wherein the communication device is a data bus with two lines for data transmission and one line for clock pulse transmission.

12. The steering wheel according to claim 11, wherein the steering wheel electronics unit polls the optical finger navigation module via the communication device.

13. The steering wheel according to claim 11, wherein the data bus is a serial peripheral interface (SPI) data bus.

14. The steering wheel according to claim 11, wherein the optical finger navigation module detects a finger movement on a surface of the optical finger navigation module as at least one differential value Which describes a distance travelled by a finger in a communications cycle.

15. The steering wheel according to claim 14, wherein the optical finger navigation module calculates a sum value from a plurality of differential values and transmits the sum value via the communication device to the steering wheel electronics unit.

16. The steering wheel according to claim 15, wherein the steering wheel electronics unit calculates a differential value from the transmitted sum value and a further stored sum value as an indicator for a finger movement.

17. The steering wheel according claim 11, wherein the steering wheel electronics unit controls a temperature compensation of the optical finger navigation module with assistance of internal data stored in the steering wheel electronics unit or provided data.

18. The steering wheel according to claim 11, wherein the steering wheel electronics unit includes a microprocessor that has at least two SPI interfaces, wherein the optical finger navigation module is connected via one of the SPI interfaces, and wherein a second optical finger navigation module is connected via another one of the SPI interfaces.

19. The steering wheel according to claim 11, wherein the steering wheel electronics unit is in communication with a column tube switch module of a longitudinal column and wherein communication between the optical finger navigation module and the steering wheel electronics unit is synchronized with the communication between the steering wheel electronics unit and the column tube switch module.

20. A motor vehicle with a steering wheel according to claim 11.
